(19) United States
(12) Patent Application Publication
(10) Pub. No.: US 2012/0177534 A1
(43) Pub. Date: Jul. 12, 2012

(54) CHEMILUMINESCENT DEVICE WITH TIME DELAY ACTIVATION

(76) Inventor: Reuven Ruby Schmerling, Amherst, MA (US)

(21) Appl. No.: 13/316,483

(22) Filed: Dec. 10, 2011

Related U.S. Application Data
(60) Provisional application No. 61/422,140, filed on Dec. 11, 2010.

(51) Int. Cl. G01N 21/76

(52) U.S. Cl. 422/52

(57) ABSTRACT

A throwable chemiluminescent device comprising a time-delay mechanism, wherein an oxalate component and a peroxide component are contained within the device. Certain embodiments are directed to a chemiluminescent device comprising a time-delay mechanism comprising at least two ampoules and an enclosure for the time-delay mechanism, wherein an oxalate component is contained in one of the at least two ampoules, and a peroxide component is contained in another of the at least two ampoules, and wherein the time-delay mechanism delays the chemiluminescent reaction of the oxalate component and the peroxide component.

The present application claims priority to U.S. Provisional Patent Application No. 61/442,140, filed Dec. 11, 2010, which is incorporated herein by reference.

The present disclosure relates to a chemiluminescent device that is suitable for propelling and that has time delay activation. The chemiluminescent device can be used in military and non-military training, and in tactical operations.

Chemiluminescent device can be used by both military and non-military organizations in training, tactical operations, and on the battlefield. These chemiluminescent devices can emit light in the visible, infrared, and ultra-violet spectrum as the result of a chemical reaction. An example of such a reaction is the activation of a fluorescer with hydrogen peroxide in the presence of a catalyst.

Traditional chemiluminescent devices are typically in the form of a tube and comprise a flexible external shell. These devices typically contain two liquid components separated from each other by a fragile barrier, such as a glass ampoule in the form of an inner tube. When light is desired from these traditional chemiluminescent devices, the separated chemical components in the device are mixed by bending the flexible tube until the glass ampoule inside the tube breaks, and then shaking the tube to mix the liquid components.

Additional chemiluminescent devibes have been proposed in which the chemiluminescence is generated by impact. These devices also contain two liquid components separated from each other by a barrier, and the components are mixed when the device impacts a target.

In certain instances, however, it may be desired to propel an unactivated chemiluminescent device to a target area, and have the device generate light after a period of time. There is therefore a need for a chemiluminescent device that can time delay the mixing of the components in the device.

It is accordingly an object in certain embodiments of the disclosure to provide a chemiluminescent device comprising a time-delay mechanism that can be triggered by the user. In certain embodiments, the time-delay mechanism can be activated by one hand of the user of the device.

One aspect of the disclosure is directed to a throwable chemiluminescent device comprising a time-delay mechanism.

Another aspect of the disclosure is directed to a throwable chemiluminescent device comprising a time-delay mechanism, wherein an oxalate component and a peroxide component are contained within the device.

Yet another aspect of the disclosure is directed to a spherically-shaped chemiluminescent device comprising a time-delay mechanism, wherein an oxalate component and a peroxide component are contained within the device.

A further embodiment of the present disclosure is directed to a throwable chemiluminescent device comprising a time-delay mechanism comprising at least two ampoules and an enclosure for the time-delay mechanism,

wherein the time-delay mechanism further comprises:

(a) a piston and a first spring, the first spring being oriented to allow movement of the piston;

(b) at least one lever, the piston being oriented to allow movement of the at least one lever; and

(c) a second spring, the second spring being oriented for movement in conjunction with the movement of the at least one lever,

wherein an oxalate component is contained in one of the at least two ampoules, and a peroxide component is contained in another of the at least two ampoules, and

wherein the time-delay mechanism delays the chemiluminescent reaction of the oxalate component and the peroxide component.

Additional objects and advantages of the disclosure will be set forth in part in the description which follows, and in part will be obvious from the description, or may be learned by practice of the disclosure. The objects and advantages of the present disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the disclosure and together with the description, serve to explain the principles of the disclosure.

### BRIEF DESCRIPTION OF THE DRAWINGS

FIG. 1 depicts a chemiluminescent device according to the present disclosure.

FIG. 2 depicts a partial view of the device of FIG. 1 with two ampoules in association with a time-delay mechanism.

FIG. 3A depicts a different view of the chemiluminescent device of FIG. 1.

FIG. 3B depicts a small orifice at the bottom wall of the piston chamber of the chemiluminescent device of FIG. 1.

FIG. 4 depicts an alternative embodiment of the device including a lever to break at least one ampoule.

FIG. 5 depicts another alternative embodiment of the device with a screw that pulls a nut with sharp corners that breaks the ampoules present in the device.

FIGS. 6A and 6B depict movement of a spring that pushes a screw with a nut that breaks the ampoules present in the device of FIG. 1.

FIG. 7 depicts a flange on the device of FIG. 1 that pushes on a lever.

FIG. 8 depicts the lever of FIG. 7 releasing a lever that releases the screw pushed by a spring.

FIG. 9 depicts a small plastic ball placed over a pin, which activates the piston.

FIG. 10 depicts an overall device according to one embodiment of the present disclosure.

FIG. 11 depicts an enclosure chemiluminescent device according to the present disclosure.

FIGS. 12, 13, and 14A depict further views of the chemiluminescent device of FIG. 1.

FIG. 14B depicts the safety pin that starts the delay in the chemiluminescent devices of FIGS. 12, 13, and 14A.

FIG. 15 depicts the chemiluminescent device of FIG. 1 contained in a enclosure, in which external wall of the enclosure was thinned in order to allow for the activation of the delay.

FIG. 16 depicts a piston seal that can be used in a chemiluminescent device according to the present disclosure.

### DESCRIPTION OF THE EMBODIMENTS

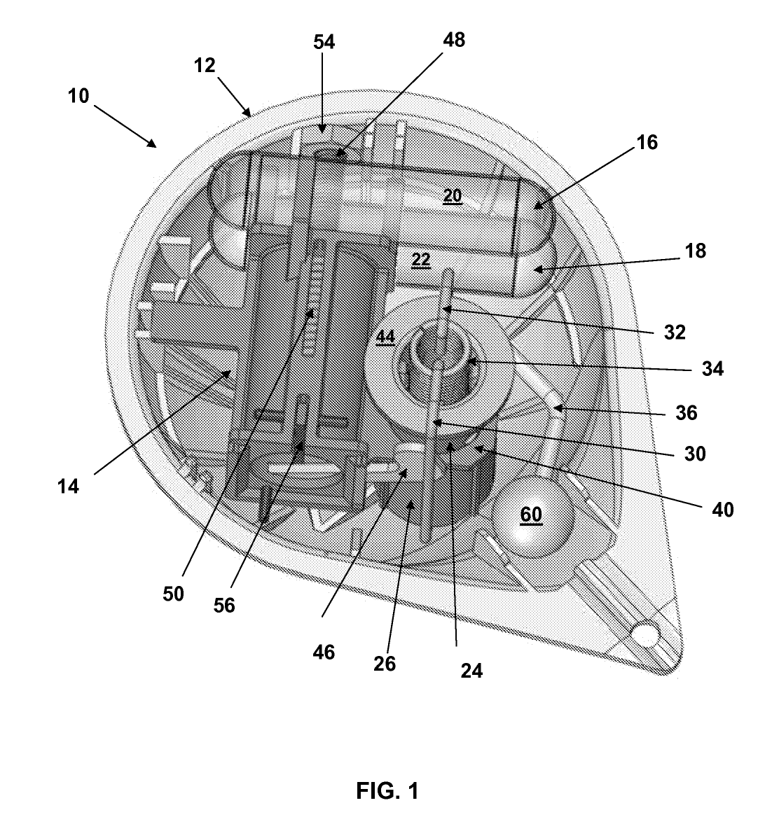

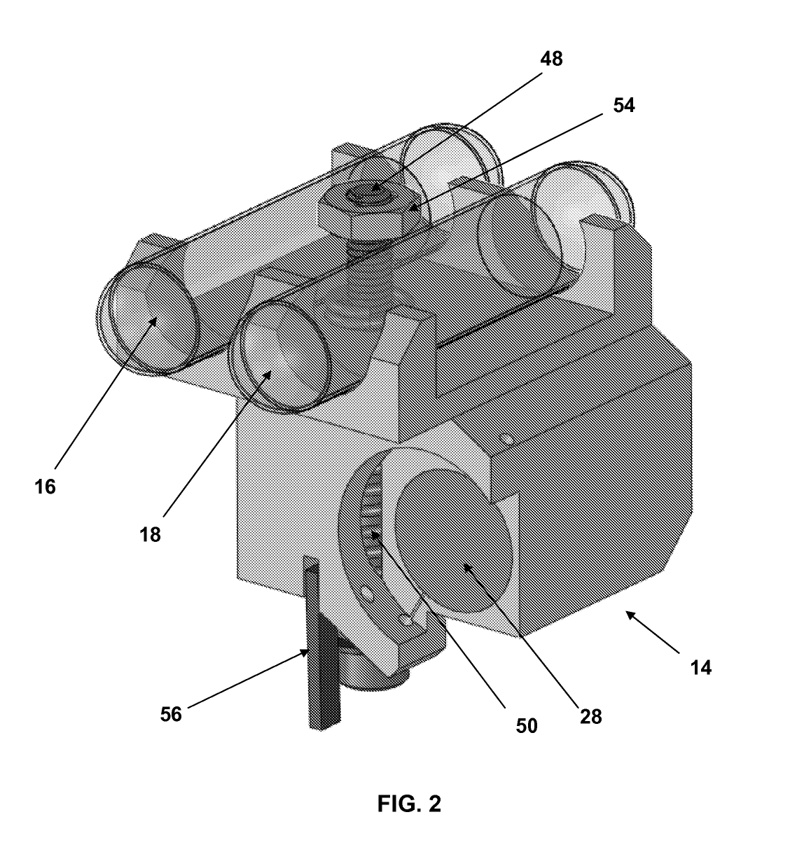

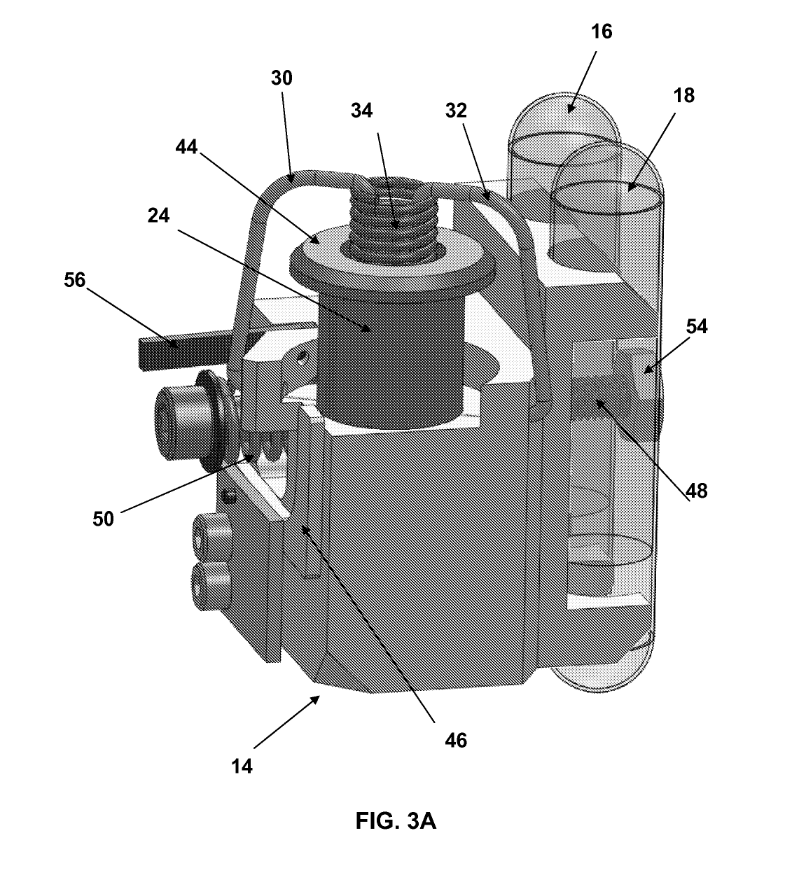

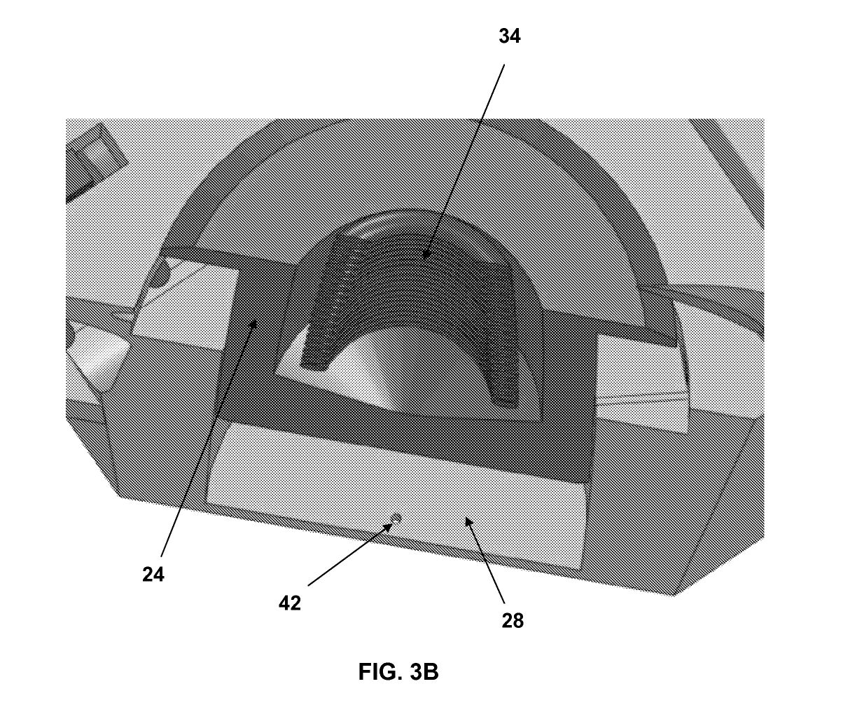

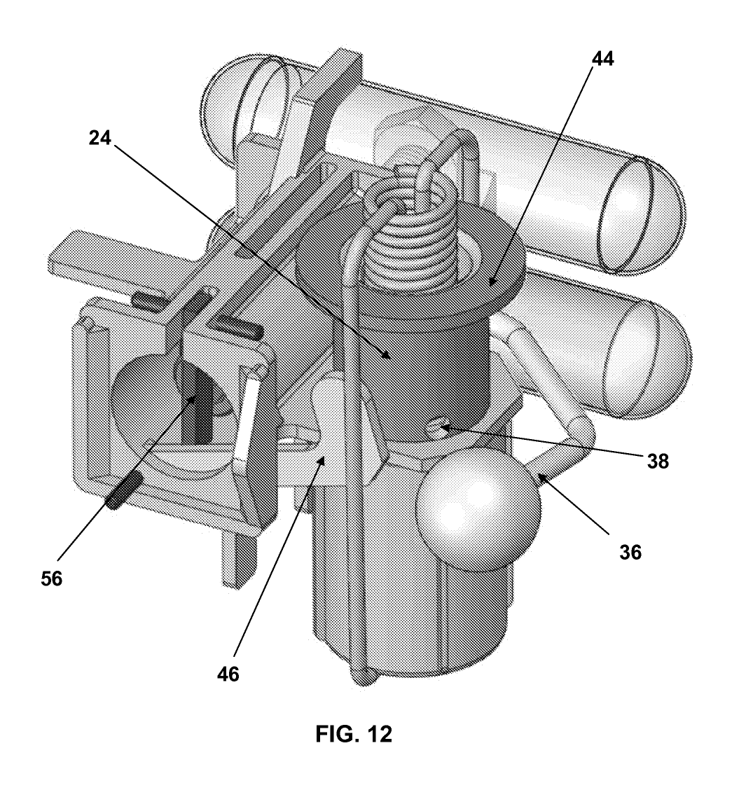

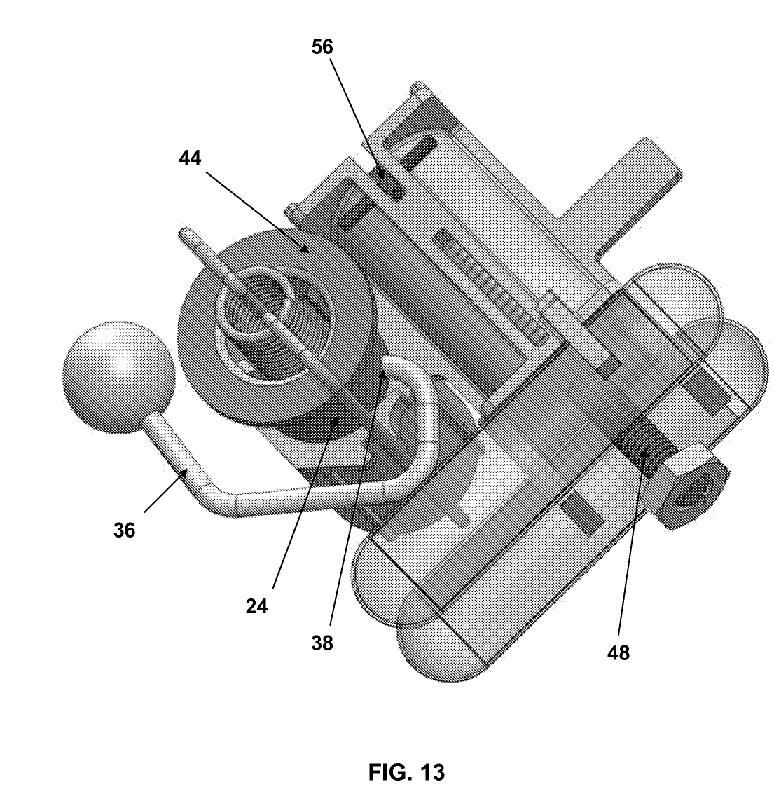

FIG. 1 depicts a chemiluminescent device 10 including an enclosure 12 formed as an external sphere that surrounds a time-delay mechanism 14 and two ampoules 16, 18 containing chemiluminescent components 20, 22. The time-delay mechanism 14 may include a piston 24 that is received for movement in a piston cylinder 26 to form a piston chamber (28 in FIGS. 2 and 3B). A plurality of spring retainers 30, 32 position a spring 34 against a back side of the piston 24 to urge the piston 24 toward the end wall of the piston chamber. In certain embodiments, the spring retainer a single part, rather than two separate parts 30 and 32. The piston 24 is secured in a pre-activation position with a pin 36 (comprising a ball 60) that is received in a pin bore (38 in FIGS. 12, 13, and 14A) of the piston 24 and urged against the open end 40 of the piston cylinder 26. Releasing the pin 36 from the pin bore 38 activates the piston 24 and allows the spring 34 to move the piston 24 toward the end wall of the piston chamber. During this movement, fluid can exit a small orifice (42 in FIG. 3B) formed in the piston chamber end wall. The size of the orifice 42 can dictate the rate at which the piston 24 moves toward the end wall. A back end of the piston includes a flange 44 that is sized to contact a release lever 46 that pivots to unlock a spring biased screw 48 when the piston 24 has moved a predetermined distance. Once the spring-biased screw 48 is unlocked, the screw 48, in conjunction with nut 54, is urged by spring 50 to break the ampoules 16, 18 and allow the chemiluminescent components 20, 22 to mix within the enclosure 12.

The time-delay mechanism 14 and ampoules 16 and 18 according to the present disclosure can be contained in an enclosure of any shape that is capable of being propelled, either by a machine or by a human. In the embodiment depicted in FIG. 1, the shape of the enclosure containing the time-delay mechanism is a sphere. Other suitable shapes for the enclosure include a football shape, a cube shape, an oblong shape, such as the shape of an egg, and a cylinder shape.

The enclosure can be formed of any material that is capable of being shaped, and that also will not adversely affect the reaction between the chemiluminescent components that react within the device. Suitable materials include thermoplastic resins such as polypropylene, low density polyethylene, high density polyethylene, and polyolefin copolymers. In certain embodiments, the two sides of the enclosure are sealed without a flange. The enclosure can be opaque, transparent and/or partially transparent. In some embodiments, the enclosure is colored in order to block visible light, but still allow infra-red light and/or ultra-violet to be detected. in certain embodiments, the enclosure is purple in color. The time delay mechanism according to the present disclosure can be contained in any of the enclosures contemplated above.

The external sphere depicted in FIG. 1 also comprises a protrusion. In certain embodiments of the present disclosure, an activation means to start the time-delay process is located in the protrusion. The time-delay process can be activated by means know in the art, such as, for example, by pulling out a pin; by pushing in a pin; by twisting a pin; by magnetic means; by shaking means; by sliding, turning, bending, flexing, pushing or pulling a lever; or by sliding, turning, bending, flexing, pushing or pulling a sliding-plate.

FIG. 2 depicts an embodiment of the time-delay mechanism 14 according to the present disclosure in which two ampoules 16, 18 are held in the mechanism between screw 48. Spring 50, which is located around screw 48, nut 54, and lever 56 are also enumerated in this figure. The ampoules can be made of any material that is fragile enough to be broken when pressure is applied to the ampoule. In certain embodiments, the ampoules are made of glass. Additional materials that are suitable to use to make the fragile containers include metal foil composites for making pouches, and plastics for making tearable pouches.

FIG. 3A depicts a different view of the time-delay mechanism 14 depicted in FIG. 2. In this figure, the time-delay mechanism 14 and two ampoules 16, 18 containing the chemiluminescent components is depicted. The time-delay mechanism 14 includes a piston 24, and spring retainers 30, 32 position a spring 34 against a back side of the piston 24 to urge the piston 24 toward the end wall of the piston chamber. In certain embodiments, depicted spring retainers 30, 32 are formed from a single spring retainer. The back end of the piston includes a flange 44 that contacts a release lever 46, which in turn activates lever 56, and unlocks a spring biased screw 48 when the piston 24 has moved a predetermined distance. Once the spring-biased screw 48 is unlocked, the screw 48, in conjunction with nut 54, is urged by spring 50 to break the ampoules 16, 18 and allow the chemiluminescent components to mix within the device's enclosure.

FIG. 3B depicts the cross section of piston 24 depicted in FIG. 3A, including a cross section of spring 34, and the piston cross section reveals a small orifice 42 that is present at the bottom wall of piston chamber 28.

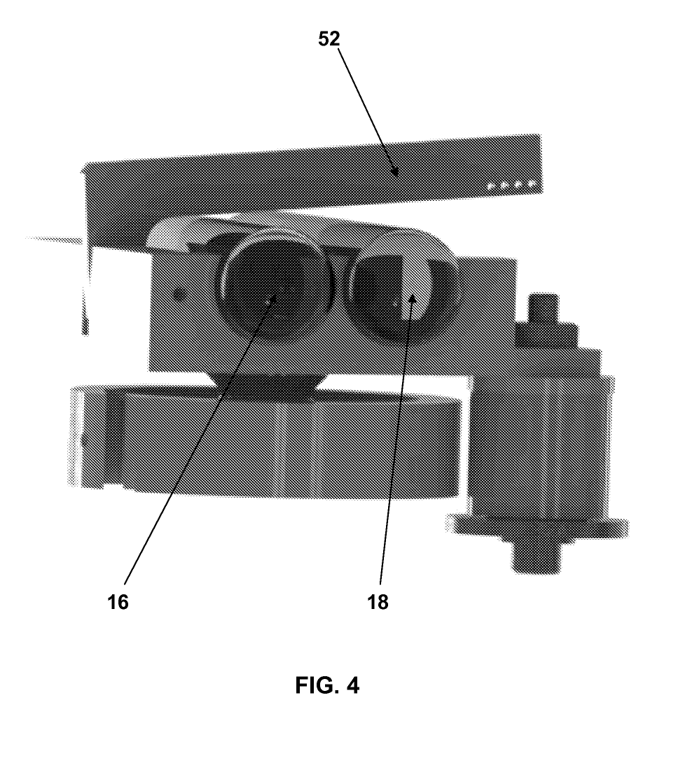

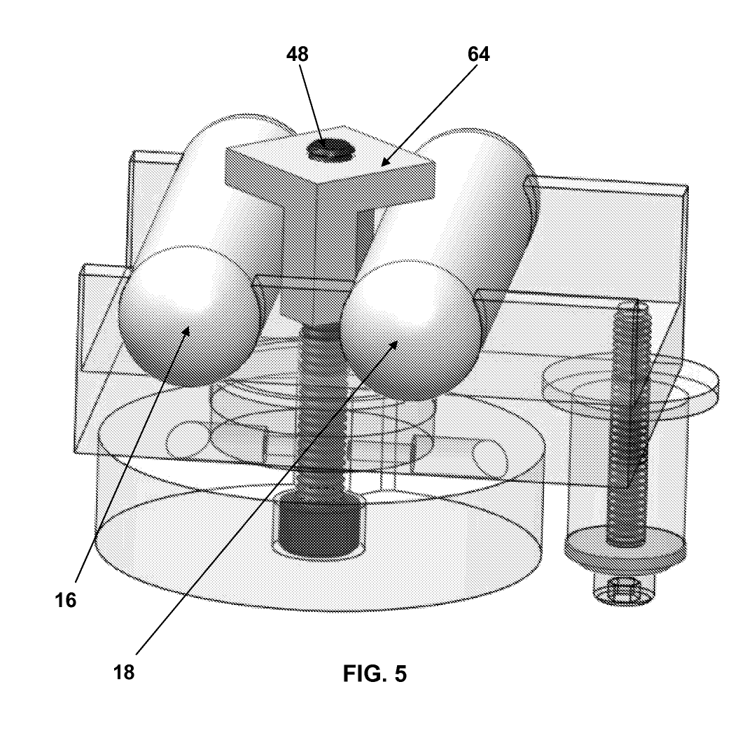

FIG. 4 and FIG. 5 depict additional embodiments of the time-delay mechanisms that can be used in accordance with the present disclosure. In FIG. 4, a lever 52 is released that causes ampoules 16, 18 to break in a chopping fashion. In FIG. 5, pressure is applied by a screw thereby causing a nut 64 containing sharp edges to compress against ampoules 16, 18.

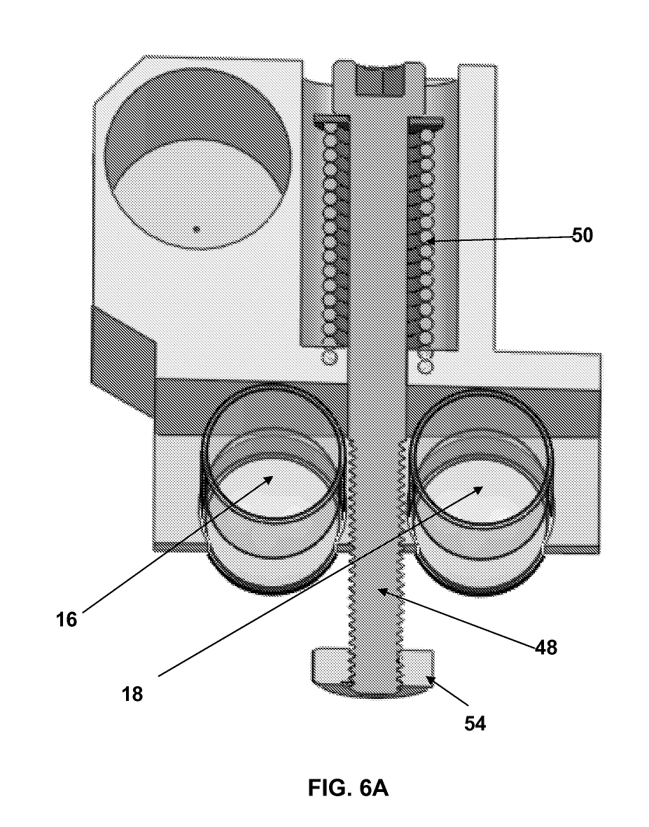

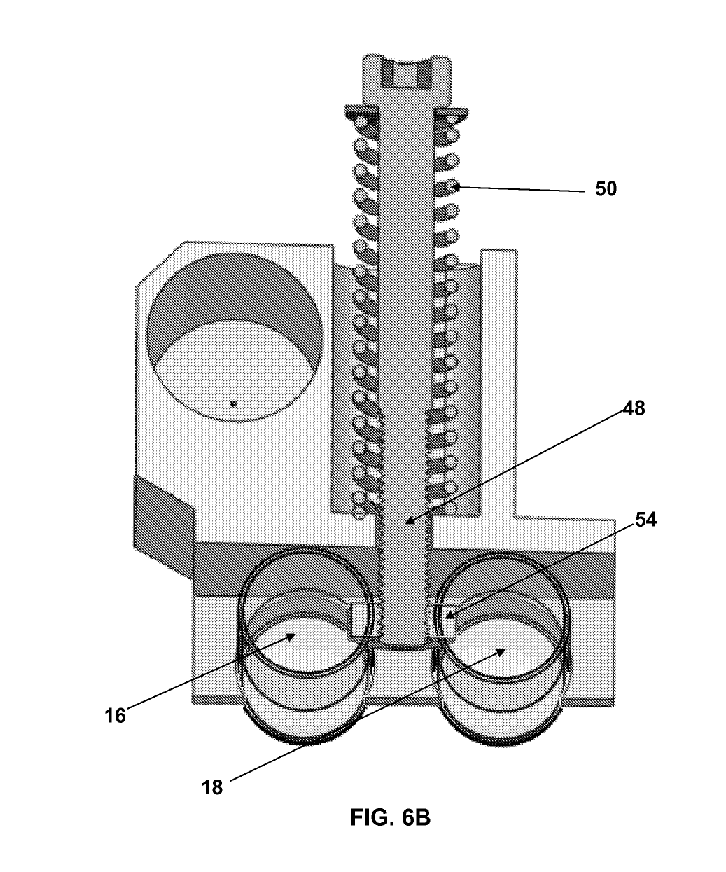

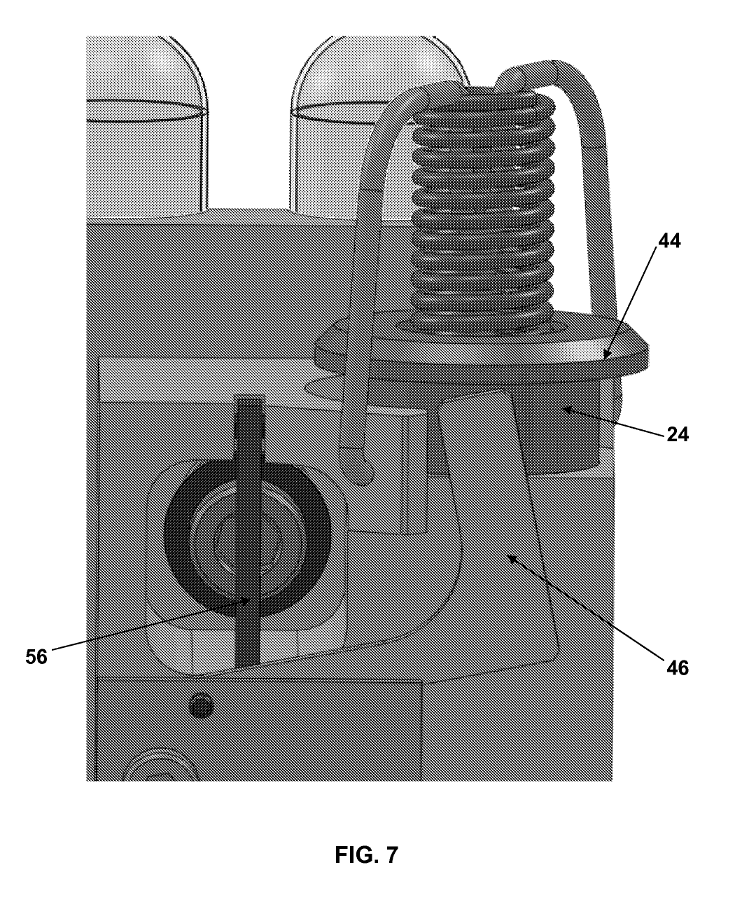

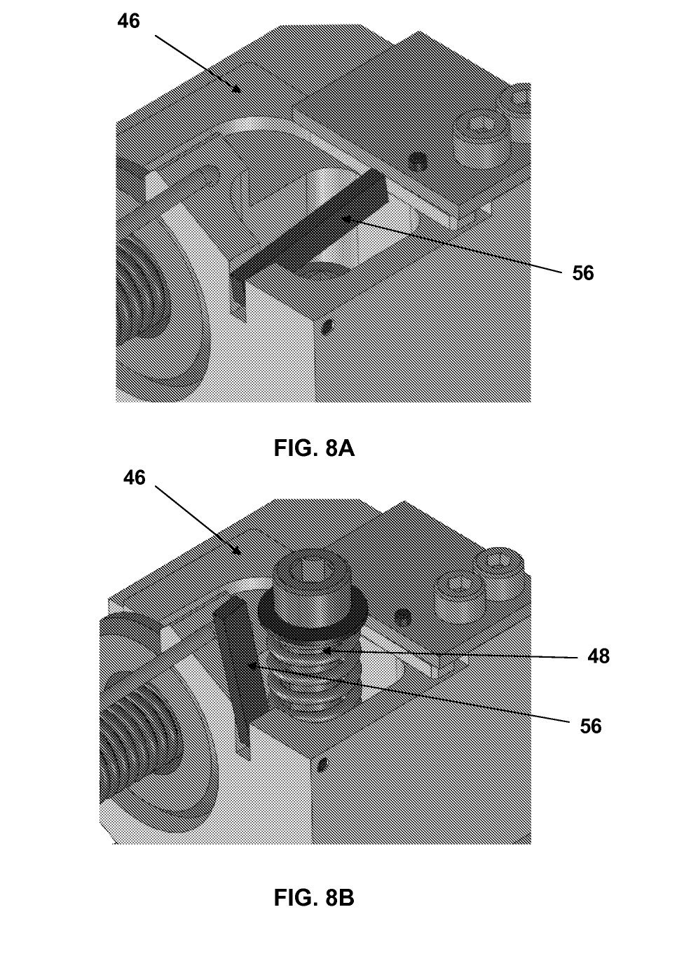

FIGS. 6A and 6B present yet other views of the time-delay mechanism depicted in FIG. 2. In FIG. 6A, spring 50 is shown, and this spring is compressed under pressure between the body of the mechanism and a lever 56, which is not shown in this figure but is depicted in FIGS. 7 and 8. In FIG. 6B the spring 50 is in the extended state and nut 54 breaks ampoules 16, 18.

FIG. 7 depicts another view of the time-delay mechanism depicted in FIG. 2. In FIG. 7, the time-delay mechanism has not yet been activated and the flange 44 and levers 46 and 56 are in a locked position.

In FIGS. 8A and 8B, however, the time-delay mechanism depicted in FIG. 2 has been activated. FIG. 8A depicts the moment in time when lever 56 has first been released. In FIG. 8B, the flange of the piston has moved the lever 46, thereby releasing lever 56, which in turn causes the screw 48 to be released. When the screw is released, the nut 54 (not shown) is caused to move toward the body of the mechanism, thereby breaking ampoules 16, 18 (not shown) contained in the mechanism. In certain embodiments, the lever 56 is released immediately after lever 46 is activated.

The materials that can be used make the components of the time-delay mechanism according to the present disclosure can be any material that does not adversely affect the reaction between the chemiluminescent components that react within the device according to the present disclosure. In certain embodiments, some of the components of the time-delay mechanism, such as the components that form the pivot points, can be made from stainless steel.

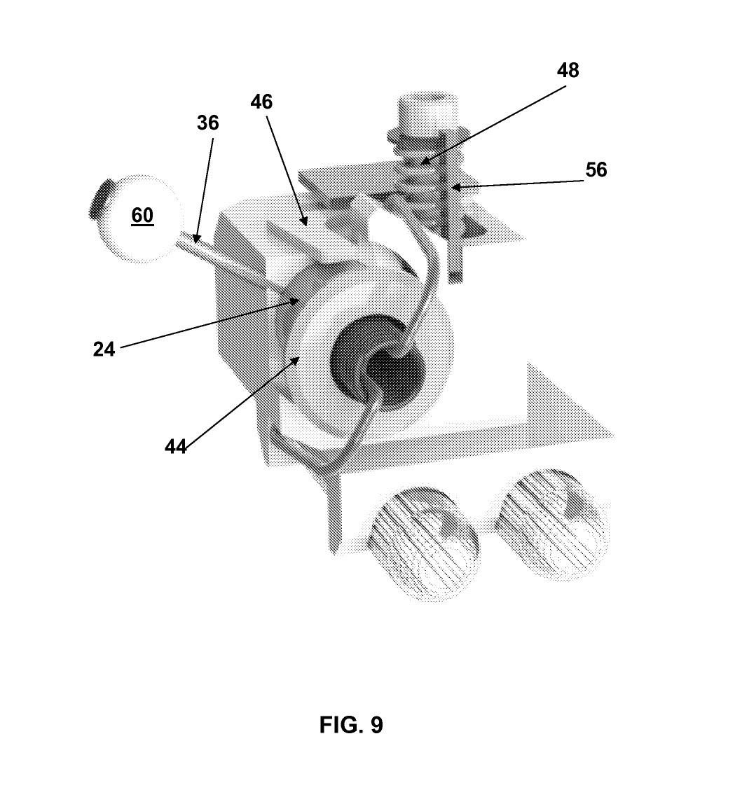

FIG. 9 depicts another embodiment that can be used to activate the time-delay mechanism according to the present disclosure. In this embodiment, pin 36 has a ball 60 placed on its end, and the ball can be grasped in order to pull the pin out of the piston. Once the pin 36 has been employed to activate the piston, the piston will move toward the mechanism in order for flange 44 to activate the lever 46, which in turn activates lever 56, which releases screw 48. The time that is taken for the piston to activate the lever 46 can be controlled by a variety of means. Features that control the time delay include, but are not limited to, (a) the piston outside diameter, (b) the cylinder inside diameter, (c) the tolerance between piston and cylinder, (d) the orifice hole diameter in the back wall of cylinder, and (e) the size of the spring that pushes the piston.

In certain embodiments, the time-delay mechanism according to the present disclosure delays time for a period ranging up to 120 seconds from the time the time-delay mechanism has been activated. For example, the time delay can range from 1 to 60 seconds, such as from 1 to 30 seconds, from 2 to 20 seconds, from 3 to 15 seconds, from 4 to 10 seconds, from 4 to 8 seconds, from 4 to 6 seconds, from 3 to 10 seconds, from 3 to 8 seconds, and from 3 to 5 seconds.

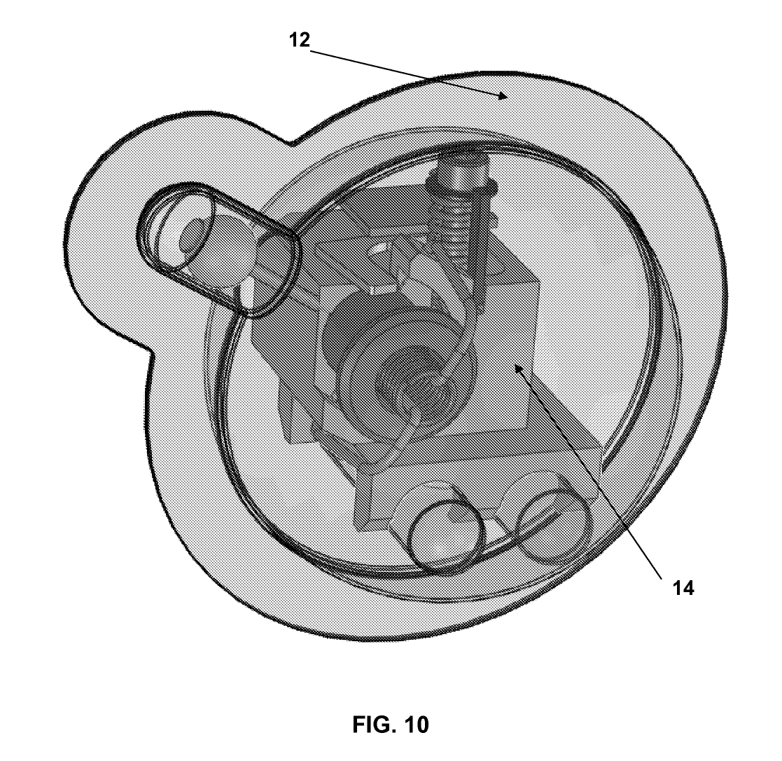

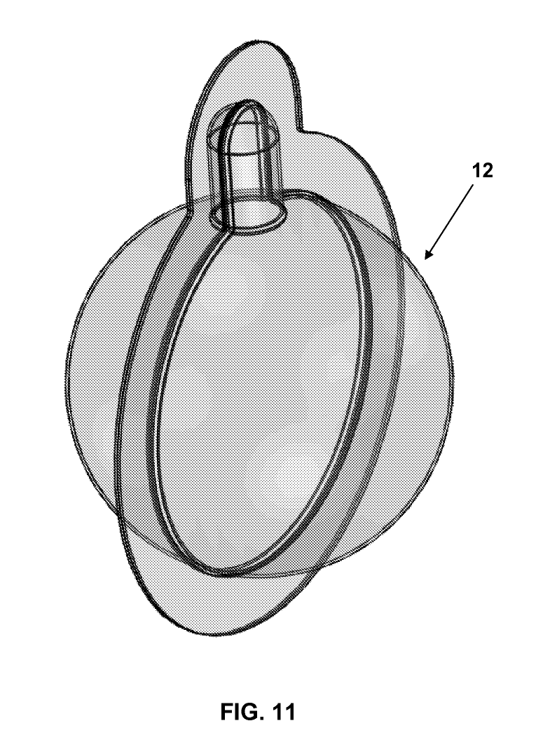

FIG. 10 depicts an overall device according to one embodiment of the present disclosure. In this figure, the time-delay mechanism 14 depicted in FIG. 9 is contained within the enclosure 12 depicted in FIG. 11.

FIG. 11 depicts the enclosure 12 for the device of FIG. 1

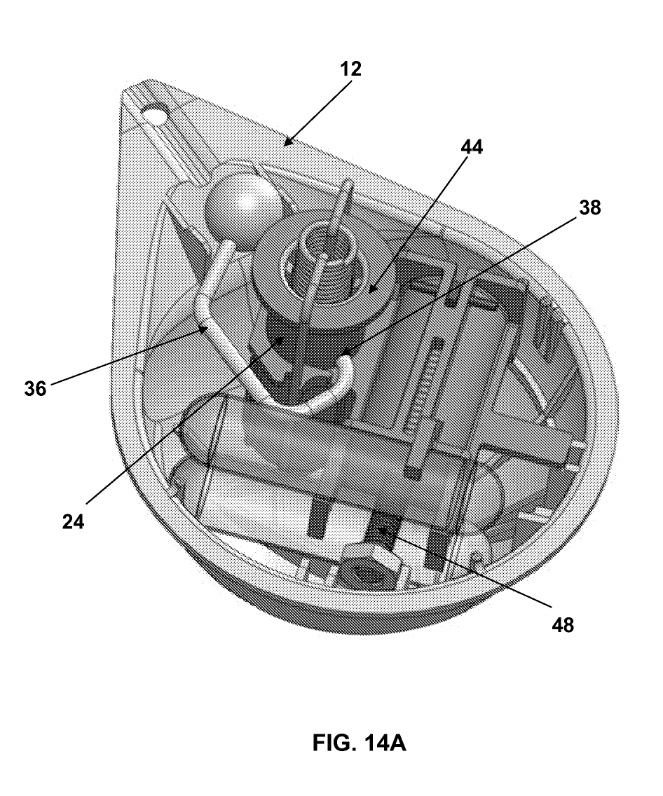

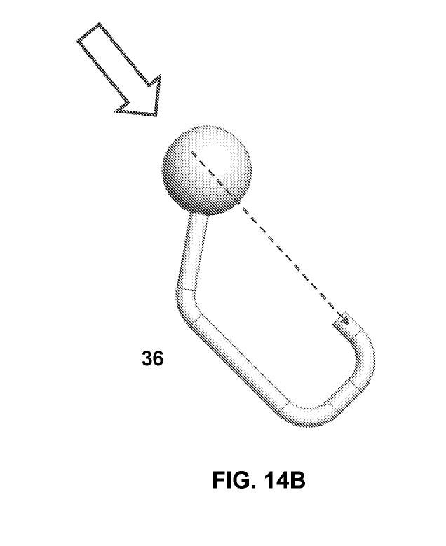

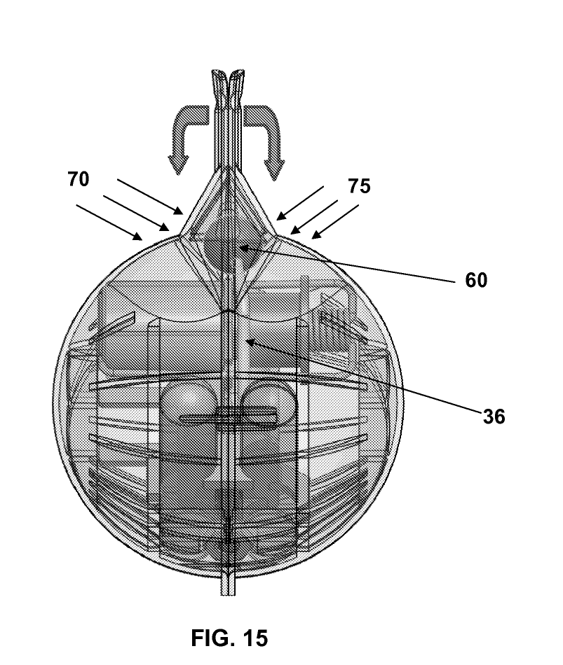

FIGS. 12, 13, and 14A depict further views of the chemiluminescent device of FIG. 1, with certain of the components highlighted with numbering consistent with FIG. 1. FIG. 14B depicts the pin 36 that starts the delay in the chemiluminescent device of FIG. 1. Force is applied to the ball by bending the device's enclosure in either direction, as depicted in FIG. 15. The force can be transferred to the safety pin in a line of action depicted in FIG. 14A, and this force moves the pin out of the piston 24, thereby allowing the piston to activate.

FIG. 15. depicts the time-delay mechanism 14 depicted in FIG. 1 contained within an enclosure 12. In this embodiment, selected portions 70, 75 of the enclosure's walls that are proximate to the ball 60 on the pin 36 are reduced in thickness, thereby allowing for easier deformation of the enclosure 12. In certain embodiments, the device is bent as depicted by applying force in the direction of at least one of the directional arrows, and the deformation causes the interior walls of the enclosure to contact the ball 60 on the pin 36 and thereby activate the delay.

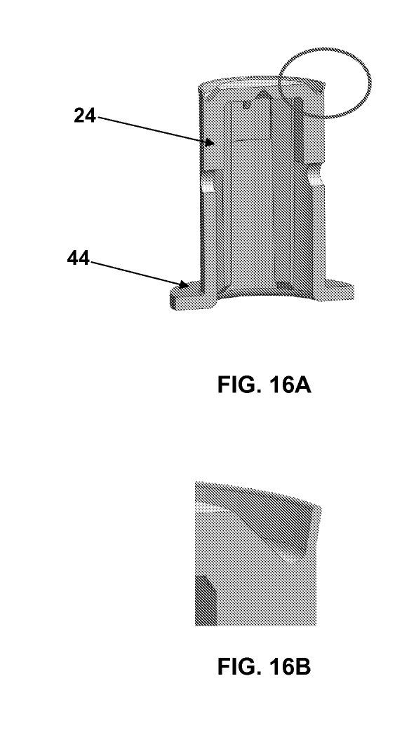

FIGS. 16A and 16B. depicts a piston 24 in accordance with one embodiment of the present disclosure. FIG. 16A depicts flange 44 on one end of the piston, and the piston seal on the other end. As seen in FIG. 16B, which is a magnified view of the piston seal in FIG. 16A, the piston seal in this embodiment is designed to have a thin wall that can be flexible. This flexibility allows the piston seal diameter to be greater than the cylinder (or piston chamber) into which it is placed, and once this piston is placed in its cylinder, the piston seal is capable of maintaining contact all around the cylinder.

The total weight of the chemiluminescent devices can vary greatly depending on the intended application for the device. For purposes of the present disclosure, the total weight of the chemiluminescent device includes the weight of the enclosure, the weight of the time-delay mechanism, and the weight of the chemiluminescent components that react within the device. In certain embodiments, the chemiluminescent device according to the present disclosure can have a weight ranging from 50 grams to 500 grams. In these embodiments, suitable weight ranges include, for example, from 75 grams to 450 grams, from 100 grams to 400 grams, from 110 grams to 350 grams, from 120 grams to 300 grams, from 130 grams to 250 grams, from 130 grams to 200 grams, from 135 grams to 175 grams, from 135 grams to 160 grams, and from 150 to 165 grams, from 155 to 165 grams, and from 140 grams to 150 grams. In one embodiment of the present disclosure, the chemiluminescent device has a total weight ranging from 140 grams to 150 grams. In another embodiment of the present disclosure, the chemiluminescent device has a total weight ranging from 155 grams to 165 grams.

In certain embodiments, the chemiluminescent device is throwable. In these embodiments, the shape of the device can be any shape that is able to be thrown by the user. Non-limiting examples of the shape of the device include shapes chosen from spherical shapes, oblong shapes, cylindrical shapes, wedge shapes, disc shapes, and football shapes. In these embodiments, the size of the device is limited only by the ability of the user to throw the device.

In certain embodiments, the device is spherically shaped and has a diameter ranging from 40 mm to 225 mm. In these embodiments, suitable diameter ranges include, for example, from 50 mm to 200 mm, from 50 mm to 150 mm, from 50 mm to 100 mm, from 60 mm to 120 mm, from 60 mm to 100 mm, from 60 mm to 80 mm, from 70 mm to 100 mm, from 70 mm to 90 mm, from 70 mm to 80 mm, from 70 mm to 75 mm, and from 72 mm to 77 mm. In one embodiment of the present disclosure, the chemiluminescent device is spherically shaped, has a total weight ranging from 140 grams to 150 grams, and has a diameter ranging from 72 mm to 77 mm. In another embodiment of the present disclosure, the chemiluminescent device is spherically shaped, has a total weight ranging from 155 grams to 165 grams, and has a diameter ranging from 70 mm to 75 mm.

The chemiluminescent device according to the present disclosure comprises at least two chemiluminescent components, which are maintained separately until activation. The first component is comprised of at least one oxalate ester, and the second component is comprised of at least one peroxide.

In certain embodiments, the first component comprising at least one oxalate ester is contained in one ampoule, and the second component comprising at least one peroxide is contained in another ampoule. In additional embodiments, the first component comprising at least one oxalate ester is contained within the ampoules present in the chemiluminescent device according to the present disclosure, and the second component comprising at least one peroxide is separately contained within the enclosure shell of the device. In yet another embodiment of the present disclosure, the second component comprising at least one peroxide is contained within the ampoules present in the chemiluminescent device according to the present disclosure, and the first component comprising at least one oxalate ester is separately contained within the enclosure shell of the device.

With respect to the first component, examples of the at least one oxalate useful in the present disclosure include bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2,4,5-trichloro-6-carboisopentoxyphenyl)oxalate; bis(2,4,5-trichloro-6-carbobenzoxyphenyl)oxalate; bis(2-nitrophenyl)oxalate; bis(2,4-dinitrophenyl)oxalate; bis(2,6-dichloro-4-nitrophenyl)oxalate; bis(2,4,6-trichlorophenyl)oxalate; bis(3-trifluoromethyl-4-nitrophenyl)oxalate; bis(2-methyl-4,6-dinitrophenyl)oxalate; bis(1,2-dimethyl-4,6-dinitrophenyl)oxalate; bis(2,4-dichlorophenyl)oxalate; bis(2,4-dinitrophenyl)oxalate; bis(2,5-dinitrophenyl)oxalate; bis(2-formyl-4-nitrophenyl)oxalate; bis(pentachlorophenyl)oxalate; bis(1,2-dihydro-2-oxo-1-pyridyl)glyoxal; bis(2,4-dinitro-6-methylphenyl)oxalate; bis-N-phthalimidyl oxalate, oxalates represented by the general formula (I)

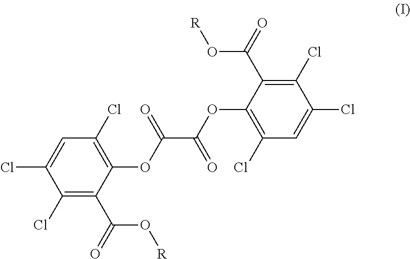

wherein R═CH₂A and A is chosen from alkyl chains, alkyl rings, and aromatic rings or combinations thereof, such that R is nonlinear and such that R comprises from 4-15 carbons, and mixtures of any of the foregoing oxalates.

Examples of oxalates represented by formula (I) include:
bis{3,4,6-trichloro-2-[(2-methylpropoxy)carbonyl]phenyl}oxalate;
bis{3,4,6-trichloro-2-[(cyclopropylmethoxy)carbonyl]phenyl}oxalate;
bis{3,4,6-trichloro-2-[(2-methylbutoxy)carbonyl]phenyl}oxalate;
bis{3,4,6-trichloro-2-[(3-methylbutoxy)carbonyl]phenyl}oxalate;
bis{3,4,6-trichloro-2-[(2,2-dimethylpropoxy)carbonyl]phenyl}oxalate;
bis{3,4,6-trichloro-2-[(2-methylpentyloxy)carbonyl]phenyl}oxalate;
bis{3,4,6-trichloro-2-[(3-methylpentyloxy)carbonyl]phenyl}oxalate;
bis{3,4,6-tri chloro-2-[(4-methylpentyloxy)carbonyl]phenyl}oxalate;
bis{3,4,6-trichloro-2-[(3,3-dimethylbutoxy)carbonyl]phenyl}oxalate;
bis{3,4,6-trichloro-2-[(2-ethylbutoxy)carbonyl]phenyl}oxalate;
bis{3,4,6-trichloro-2-[(cyclopentylmethoxy)carbonyl]phenyl}oxalate;
bis{3,4,6-trichloro-2-[(2-methylhexyloxy)carbonyl]phenyl}oxalate;
bis{3,4,6-trichloro-2-[(3-methylhexyloxy)carbonyl]phenyl}oxalate;
bis{3,4,6-trichloro-2-[(4-methylhexyloxy)carbonyl]phenyl}oxalate;
bis{3,4,6-trichloro-2-[(5-methylhexyloxy)carbonyl]phenyl}oxalate;
bis{3,4,6-trichloro-2-[(cyclohexylmethoxy)carbonyl]phenyl}oxalate;
bis{3,4,6-trichloro-2-[(phenylmethoxy)carbonyl]phenyl}oxalate;
bis{3,4,6-trichloro-2-[(2-phenylethoxy)carbonyl]phenyl}oxalate;
bis(3,4,6-trichloro-2-{[(2-methylphenyl)methoxy]carbonyl}phenyl)oxalate;
bis(3,4,6-trichloro-2-{[(3-methylphenyl)methoxy]carbonyl}phenyl) oxalate;
bis(3,4,6-trichloro-2-{[(4-methylphenyl)methoxy]carbonyl}phenyl)oxalate;
bis(3,4,6-trichloro-2-{[(2,3-dimethylphenyl)methoxy]carbonyl}phenyl)oxalate;
bis(3,4,6-trichloro-2-{[(2,4-dimethylphenyl)methoxy]carbonyl}phenyl)oxalate;
bis(3,4,6-trichloro-2-{[3,4-dimethylphenyl)methoxy]carbonyl}phenyl)oxalate;
bis(3,4,6-trichloro-2-{[(3,5-dimethylphenyl)methoxy]carbonyl}phenyl)oxalate;
bis(3,4,6-trichloro-2-{[(2,6-dimethylphenyl)methoxy]carbonyl}phenyl)oxalate;
bis(3,4,6-trichloro-2-{[(2-ethylphenyl)methoxy]carbonyl}phenyl)oxalate;
bis(3,4,6-trichloro-2-{[(3-ethylphenyl)methoxy]carbonyl}phenyl)oxalate;
bis(3,4,6-trichloro-2-{[(4-ethylphenyl)methoxy]carbonyl}phenyl)oxalate;
bis(3,4,6-trichloro-2-{[2-(2-methylphenyl)ethoxy]carbonyl}phenyl)oxalate;
bis(3,4,6-trichloro-2-{[2-(3-methylphenyl)ethoxy]carbonyl}phenyl)oxalate;
bis(3,4,6-trichloro-2-{[2-(4-methylphenyl)ethoxy]carbonyl}phenyl)oxalate;
bis{3,4,6-trichloro-2-[(2-phenylpropoxy)carbonyl]phenyl}oxalate;
bis{3,4,6-trichloro-2-[(3-phenylpropoxy)carbonyl]phenyl}oxalate;
bis{3,4,6-trichloro-2-[1-naphthalenylmethoxy)carbonyl]phenyl}oxalate;
bis{3,4,6-trichloro-2-[2-naphthalenylmethoxy)carbonyl]phenyl}oxalate;
bis{3,4,6-trichloro-2-[(2,2-diphenylethoxy)carbonyl]phenyl}oxalate;
bis{3,4,6-trichloro-2-[(9-fluorenylmethoxy)carbonyl]phenyl}oxalate; and
bis{3,4,6-trichloro-2-[(9-anthracenylmethoxy)carbonyl]phenyl}oxalate.

Additional examples of oxalates represented by general formula (I) are disclosed in U.S. Published Application No. 2011-0084243, the disclosure of such oxalates being incorporated herein by reference.

In certain embodiments, the first component can further comprise at least one fluorescer. Examples of the at least one fluorescer useful in the present disclosure include 1-methoxy-9,10-bis(phenylethynyl)anthracene, perylene, rubrene, 16,17-didecycloxyviolanthrone, 2-ethyl-9,10-bis(phenylethynyl)anthracene; 2-chloro-9,10-bis(4-ethoxyphenyl)anthracene; 2-chloro-9,10-bis(4-methoxyphenyl)anthracene; 9,10-bis(phenylethynyl)anthracene; 1-chloro-9,10-bis(phenylethynyl)anthracene; 1,8-dichloro-9,10-bis(phenylethynyl)anthracene; 1,5-dichloro-9,10-bis(phenylethynyl)anthracene; 2,3-dichloro-9,10-bis(phenylethynyl)anthracene; 5,12-bis(phenylethynyl)tetracene; 9,10-diphenylanthracene; 1,6,7,12-tetraphenoxy-N,N′-bis(2,6-diisopropylphenyl)-3,4,9,10-perylene dicarboximide; 1,6,7,12-tetraphenoxy-N,N′-bis(2,5-di-t-butylphenyl)-3,4,9,10-perylene dicarboximide; 1,7-di-chloro-6,12-diphenoxy-N,N′-bis(2,6-diisopropylphenyl)-3,4,9,10-perylene dicarboximide; 1,6,7,12-tetra(p-bromophenoxy)-N,N′-bis(2,6-diisopropylphenyl)-3,4,9,10-perylene dicarboximide; 1,6,7,12-tetraphenoxy-N,N′-di-neopentyl-3,4,9,10-perylene dicarboximide; 1,6,7,12-tetra(p-t-butylphenoxy)N,N′-dineopentyl-3,4,9,10-perylene dicarboximide; 1,6,7,12-tetra(o-chlorophenoxy)-N,N′-bis(2,6-diisopropylphenyl)-3,4,9,10-perylene dicarboximide; 1,6,7,12-tetra(p-chlorophenoxy)-N,N′-bis(2,6-diisopropylphenyl)-3,4,9,10-perylene dicarboximide; 1,6,7,12-tetra(o-fluorophenoxy)-N,N′-bis(2,6-diisopropylphenyl)-3,4,9,10-perylene dicarboximide; 1,6,7,12-tetra(p-fluorophenoxy)-N,N′ bis(2,6-diisopropylphenyl)-3,4,9,10-perylene dicarboximide; 1,6,7,12-tetraphenoxy-N,N′-diethyl-3,4,9,10-perylene dicarboximide; 1,7-dibromo-6,12-diphenoxy-N,N′-bis(2-isopropylphenyl)-3,4,9,10-perylene dicarboximide; 16,17-dihexyloxyviolanthrone; rubrene; 1,4-dimethyl-9,10-bis(phenylethynyl)anthracene, and mixtures thereof.

The amount of the at least one oxalate and the at least one fluorescer employed is upwardly limited only by the solubility of the ester and fluorescer in the solvent chosen. However, as would be appreciated by one in the art, the efficiency of the reaction would decrease at certain high concentrations.

In certain embodiments, the at least one oxalate is present in an amount ranging from 3 percent to 60 percent by weight, based on the total weight of the two-part composition. For example, the at least one oxalate can be present in an amount ranging from 3 percent to 50 percent by weight, based on the total weight of the two-part composition, such as from 3 percent to 40 percent by weight, from 3 percent to 30 percent by weight, from 5 percent to 25 percent by weight, and from 7 percent to 25 percent by weight. In certain embodiments, the at least one fluorescer is present in an amount ranging from 0.05 percent to 0.9 percent by weight based on the total weight of the two-part composition. For example, the at least one fluorescer can be present in an amount ranging from greater than 0.05 percent by weight to 0.9 percent by weight, based on the total weight of the two-part composition, such as from greater than 0.1 percent by weight, from greater than 0.2 percent by weight, from greater than 0.3 percent by weight, from greater than 0.4 percent by weight, from greater than 0.5 percent by weight, from greater than 0.6 percent by weight, from greater than 0.7 percent by weight, and from greater than 0.8 percent by weight. In addition, the at least one fluorescer can be present in an amount ranging from 0.05 percent by weight to less than 0.9 percent by weight, based on the total weight of the two-part composition, such as from less than 0.8 percent by weight, from less than 0.7 percent by weight, from less than 0.6 percent by weight, from less than 0.5 percent by weight, from less than 0.4 percent by weight, from less than 0.3 percent by weight, from less than 0.2 percent by weight, and from less than 0.1 percent by weight. It is also intended that the amount of the at least one oxalate and the at least one fluorescer can range between any of the numerical values listed above.

With respect to the second component, examples of the at least one peroxide useful in the present disclosure include hydrogen peroxide; sodium peroxide; sodium perborate; sodium pyrophosphate peroxide; urea peroxide; histidine peroxide; t-butyl-hydroperoxide; and peroxybenzoic acid, and mixtures thereof. In certain embodiments, the at least one peroxide is present in an amount ranging from 0.25 percent to 25 percent by weight, based on the total weight of the two-part composition. For example, the at least one peroxide can be present in an amount ranging from 0.25 percent to 20 percent by weight, based on the total weight of the two-part composition, such as from 0.5 percent to 20 percent by weight, from 0.5 percent to 15 percent by weight, from 0.5 percent to 10 percent by weight, and from 0.5 percent to 6 percent by weight. In certain embodiments, the at least one peroxide of the present disclosure can be hydrogen peroxide.

In certain embodiments, the second component can further comprise at least one catalyst. Examples of the at least one catalyst useful in the present disclosure include sodium salicylate, lithium salicylate, 5-chlorolithium salicylate, triazoles (e.g., 1,2,3-triazole and 1,2,4-triazole), substituted triazoles (e.g., substituted 1,2,3-triazole and substituted 1,2,4-triazole), imidazoles, and substituted imidazoles.

In certain embodiments, the at least one catalyst is present in an amount ranging from 0.0005 percent to 0.5 percent by weight, based on the total weight of the two-part composition. For example, the at least one catalyst can be present in an amount ranging from greater than 0.0005 percent by weight to 10 percent by weight, based on the total weight of the two-part composition, such as from 0.001 percent or greater by weight, from 0.005 percent or greater by weight, from 0.01 percent or greater by weight, from 0.05 percent or greater by weight, from 0.1 percent or greater by weight, from 0.25 percent or greater by weight, from 0.5 percent or greater by weight, from 1 percent or greater by weight, from 1.5 percent or greater by weight, from 2 percent or greater by weight, from 2.5 percent or greater by weight, from 3 percent or greater by weight, from 3.5 percent or greater by weight, from 4 percent or greater by weight, from 4.5 percent or greater by weight, from 5 percent or greater by weight, and from 7.5 percent or greater by weight. In addition, the at least one catalyst can be present in an amount ranging from 0.0005 percent by weight to less than 10 percent by weight, based on the total weight of the two-part composition, such as from 7.5 percent or less by weight, from 5 percent or less by weight, from 4.5 percent or less by weight, from 4 percent or less by weight, from 3.5 percent or less by weight, from 3 percent or less by weight, from 2.5 percent or less by weight, from 2 percent or less by weight, from 1.5 percent or less by weight, from 1 percent or less by weight, from 0.5 percent or less by weight, from 0.25 percent or less by weight, from 0.1 percent or less by weight, from 0.05 percent or less by weight, from 0.01 percent or less by weight, from 0.005 percent or less by weight, and from 0.001 percent or less by weight. It is also intended that the amount of at least one catalyst can range between any of the numerical values listed above.

The chemiluminescent device according to the present disclosure can also comprise at least one carrier in the first and/or second component. Examples of the at least one carrier useful in the present disclosure include dimethyl phthalate, dibutyl phthalate, dioctal phthalate, butyl benzoate, acetyl triethyl citrate, triethyl citrate, ethylene glycol dibenzoate, and propylene glycol dialkyl ether containing one to three propylene moieties and each alkyl group is independently a straight-chain or branched-chain alkyl group containing up to 8 carbon atoms. Exemplary solvents include dimethyl phthalate, triethyl citrate, ethylene glycol dibenzoate, propylene glycol dialkyl ethers containing two propylene moieties such as dipropylene glycol dimethyl ether, dipropylene glycol diethyl ether and dipropylene glycol di-t-butyl ether, dibutyl phthalate, butyl benzoate, propylene glycol dibenzoate, ethyl-hexyl diphenyl phosphate, and mixtures thereof.

In certain embodiments, the at least one carrier is present in an amount ranging from 5 percent to 95 percent by weight, based on the total weight of the two-part composition. For example, the at least one carrier can be present in an amount ranging from greater than 5 percent by weight to 95 percent by weight, based on the total weight of the two-part composition, such as from greater than 10 percent by weight, from greater than 20 percent by weight, from greater than 30 percent by weight, from greater than 40 percent by weight, from greater than 50 percent by weight, from greater than 60 percent by weight, from greater than 70 percent by weight, from greater than 80 percent by weight, and from greater than 90 percent by weight. In addition, the at least one carrier can be present in an amount ranging from 5 percent by weight to less than 95 percent by weight, based on the total weight of the two-part composition, such as from less than 90 percent by weight, from less than 80 percent by weight, from less than 70 percent by weight, from less than 60 percent by weight, from less than 50 percent by weight, from less than 40 percent by weight, from less than 30 percent by weight, from less than 20 percent by weight, and from less than 10 percent by weight. It is also intended that the amount of at least one carrier can range between any of the numerical values listed above.

The light generated upon activation of the chemiluminescent device according to the present disclosure may be light visible in the ultra-violet, infra-red and/or visible light spectrums. In certain embodiments, visible light is generated upon activation of the chemiluminescent device and this light last for up to 5 minutes, such as, for example, up to 4 minutes, up to 3 minutes, up to 2 minutes, up to 1 minute, up to 45 seconds, up to 30 seconds, and up to 20 seconds. In certain embodiments, infra-red light is generated upon activation of the chemiluminescent device and this light last for up to 60 minutes, such as, for example, up to 50 minutes, up to 45 minutes, up to 40 minutes, up to 30 minutes, up to 20 minutes, up to 15 minutes, up to 10 minutes, and up to 5 minutes. It is contemplated that the chemiluminescent device according to the present disclosure can generate light in the ultra-violet spectrum, the infra-red spectrum, the visible light spectrum, and any combination thereof.

Additional components that may be included in either component of the chemiluminescent device include, but are not limited to, thickeners to allow the marker to stick to the target better, fluorescent powders for day time target marking, and antifreeze agents to prevent freezing, film formers, gelling agents, polyacrylamides, and polyvinylchloride. These additional components are those well known in the art to be suitable for the above purposes.

What is claimed is:

1. A throwable chemiluminescent device comprising a time-delay mechanism comprising at least two ampoules and an enclosure for the time-delay mechanism,
wherein the time-delay mechanism further comprises:
(a) a piston and a first spring, the first spring being oriented to allow movement of the piston;
(b) at least one lever, the piston being oriented to allow movement of the at least one lever; and
(c) a second spring, the second spring being oriented for movement in conjunction with the movement of the at least one lever,
wherein an oxalate component is contained in one of the at least two ampoules, and a peroxide component is contained in another of the at least two ampoules, and
wherein the time-delay mechanism delays the chemiluminescent reaction of the oxalate component and the peroxide component.

2. The chemiluminescent device according to claim 1, wherein the device is spherically shaped.

3. The chemiluminescent device according to claim 2, wherein the total weight of the device ranges from 135 grams to 175 grams.

4. The chemiluminescent device according to claim 2, wherein the diameter of the device ranges from 70 mm to 80 mm.

5. The chemiluminescent device according to claim 1, wherein the device is spherically shaped, has a total weight ranging from 140 grams to 150 grams, and has a diameter ranging from 72 mm to 77 mm.

6. The chemiluminescent device according to claim 1, wherein the device is spherically shaped, has a total weight ranging from 155 grams to 165 grams, and has a diameter ranging from 70 mm to 75 mm.

7. The chemiluminescent device according to claim 1, wherein the enclosure is transparent.

8. The chemiluminescent device according to claim 1, wherein the enclosure is colored in order to block visible light upon activation of the time-delay mechanism.

9. The chemiluminescent device according to claim 1, wherein the time-delay mechanism delays the chemiluminescent reaction for a period of time ranging from 3 to 10 seconds.

10. The chemiluminescent device according to claim 1, wherein the delayed chemiluminescent reaction generates visible light for up to 2 minutes and/or generates infra-red light for up to 40 minutes.

11. A spherical chemiluminescent device comprising a time-delay mechanism comprising at least two ampoules and an enclosure for the time-delay mechanism,
wherein the time-delay mechanism further comprises:
(a) a piston and a first spring, the first spring being oriented to allow movement of the piston;
(b) at least one lever, the piston being oriented to allow movement of the at least one lever; and
(c) a second spring, the second spring being oriented for movement in conjunction with the movement of the at least one lever,
wherein an oxalate component is contained in one of the at least two ampoules, and a peroxide component is contained in another of the at least two ampoules.

12. The spherical chemiluminescent device according to claim 10, wherein, upon activation, the movements of the piston, the at least one lever, and the at least one spring facilitate the breaking of the ampoules.

13. The chemiluminescent device according to claim 11, wherein the device has a total weight ranging from 140 grams to 150 grams, and has a diameter ranging from 72 mm to 77 mm.

14. The chemiluminescent device according to claim 1, wherein the device has a total weight ranging from 155 grams to 165 grams, and has a diameter ranging from 70 mm to 75 mm.

15. The chemiluminescent device according to claim 1, wherein the time-delay mechanism is designed to be activated by one hand.
